(19) United States
(12) Patent Application Publication
(10) Pub. No.: US 2011/0225880 A1
(43) Pub. Date: Sep. 22, 2011

(54) Device for Displaying and Keeping Bouquets of Flowers

(76) Inventor: Philippe Charrin, Beaumont-Monteux (FR)

(21) Appl. No.: 12/671,564

(22) PCT Filed: Aug. 11, 2008
(86) PCT No.: PCT/EP08/60527

§ 371 Date: Feb. 1, 2010

(30) Foreign Application Priority Data
Aug. 10, 2007 (LU) 91354

(51) Int. Cl. A01G 5/06; A47G 7/00

(52) U.S. Cl. 47/41.01; 248/27.8

(57) ABSTRACT

Device for displaying and keeping individual bouquets of flowers, whereby the flowers are held in position on the vertical central axis (7) of the erected device, comprising a holder (1) from which strips (2) extend along the direction of said vertical central axis (7), said device being characterized in that the strips (2) possess one or more retaining teeth (5) and in that an automatic closure ring (6) is in contact with said strips (2), said ring (6) enabling the diameter of the variable opening of the erected device to be adjusted.

The present invention concerns a device for displaying and keeping bouquets of flowers according to claims 1 and 11.

Patent EP 0828 446 describes a device for displaying bouquets comprising a foldable support, a plurality of strips, a fastening means wound around the strips, a watertight sheet, a first fastening of the device and a second fastening formed by a ribbon. This device is restrictive and requires mastery of the closing technique.

Patent EP 0881 167 discloses a container for bouquets of flowers comprising a circular base element from which a plurality of elongated elements extend.

French model 944871 is delivered flat with peripheral tabs which one raises to ensure stability while maintaining it by a fastening means either directly around the tabs or around the watertight wrapping paper. The drawback is that the assembly is restrictive and slow and the device is not very stable.

French model 944529 is delivered erected with tabs positioned vertically on the periphery. It requires a first manual connection to make the bouquet integral with the support. The drawback is that this device is bulky, not adjustable, and assembly is slow.

The device for displaying and keeping bouquets of flowers is defined in claim 1 and claim 11 of the present invention.

The aim of and problem to be resolved by the invention is the quick display of a bouquet of flowers in the vertical position and the preservation of this bouquet by introducing water through an orifice situated at the upper portion of the device.

Another aim and problem to be resolved is to create stability for all types of bouquets.

The present invention will be better understood in reference to the following figures:

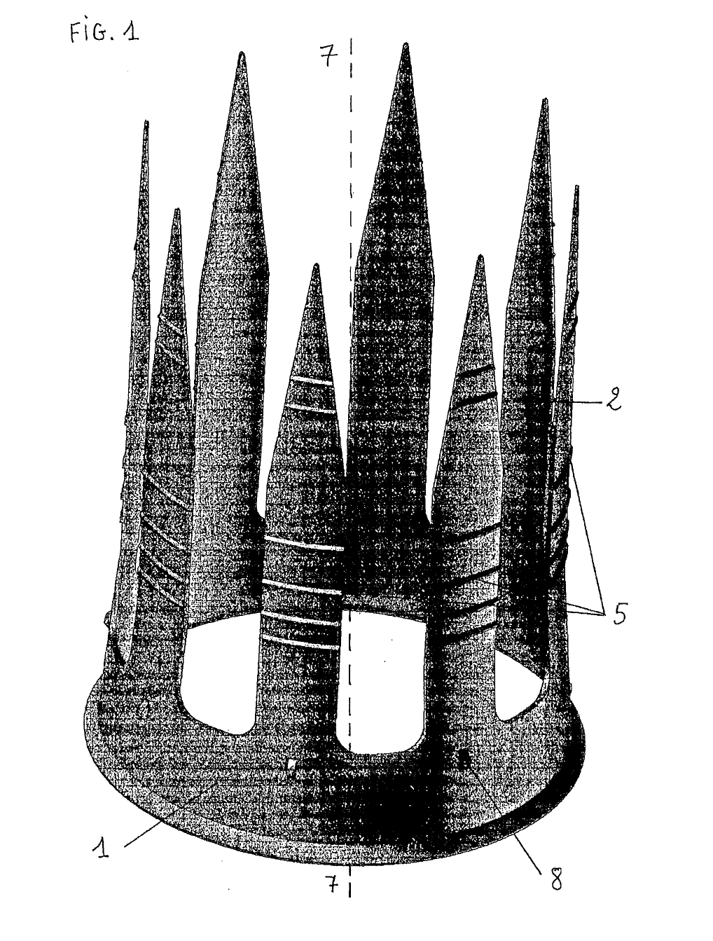

FIG. 1 illustrates a first embodiment of the device according to the present invention in a single molded cylindrical piece.

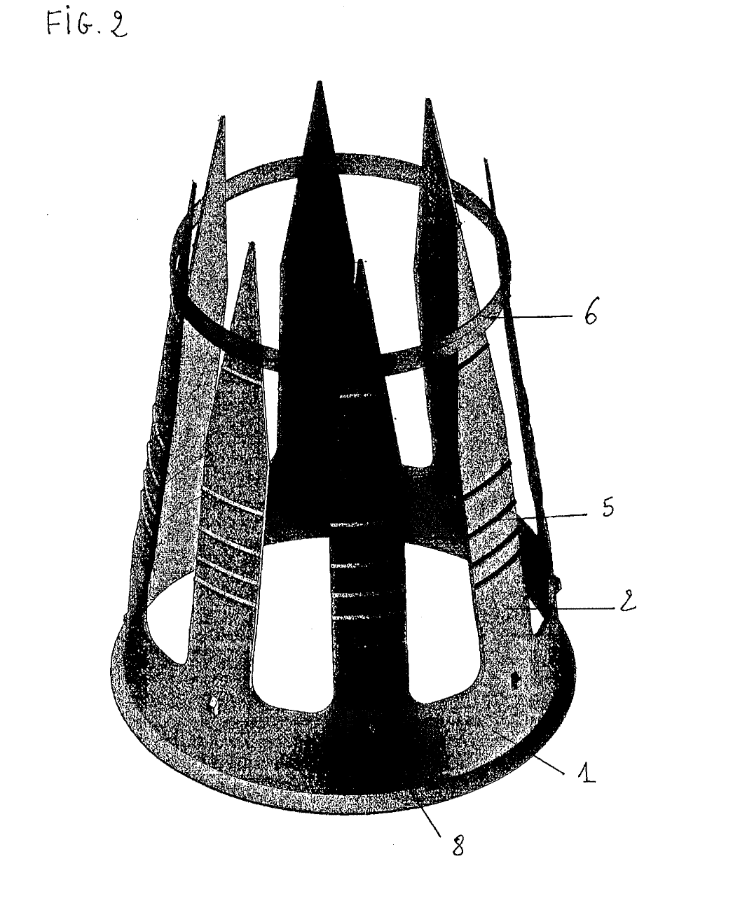

FIG. 2 illustrates the device according to the present invention with the ring (6) placed at the apex of the strips (2).

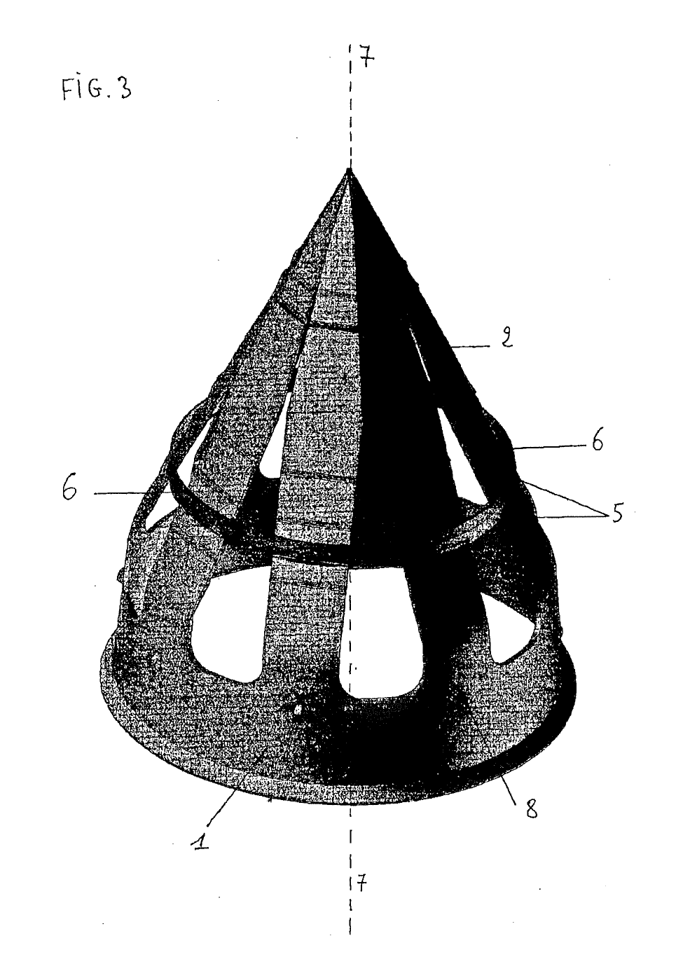

FIG. 3 illustrates the device according to the present invention with the ring (6) in the final position and the strips (2) forming a point for maintaining flowers. The device has a conical shape in its final position.

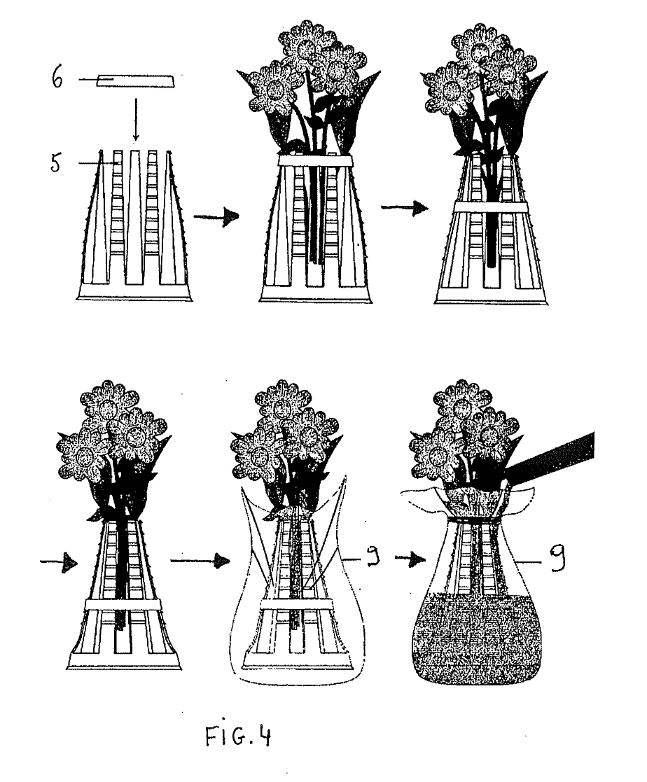

FIG. 4 illustrates a descriptive diagram of the different steps in assembling the device according to the present invention.

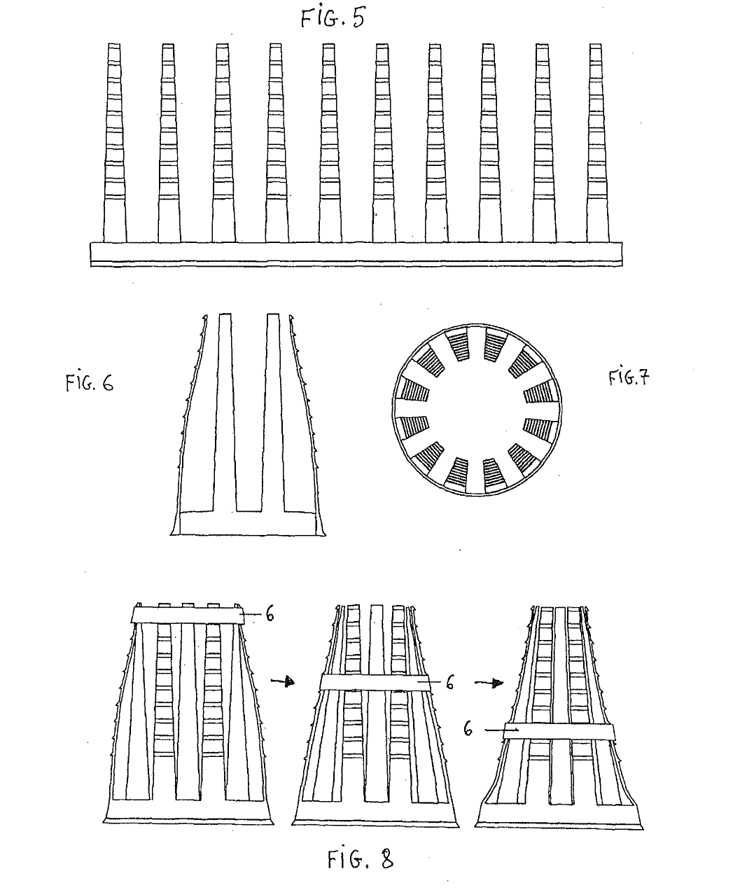

FIG. 5 illustrates a second embodiment of the device according to the present invention delivered flat.

FIG. 6 illustrates a cross-sectional view of the assembled device according to the present invention.

FIG. 7 illustrates a top view of the device according to the present invention.

FIG. 8 illustrates the device according to the present invention with the ring (6) in its initial position, then its intermediate and lastly final positions.

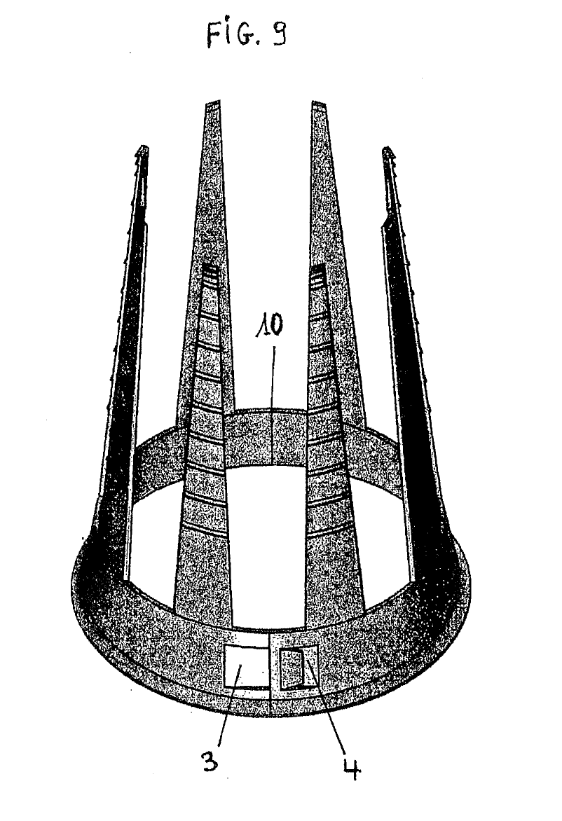

FIG. 9 illustrates a third embodiment of the device according to the present invention with the male (3) and female (4) closing elements, and the hinge (10).

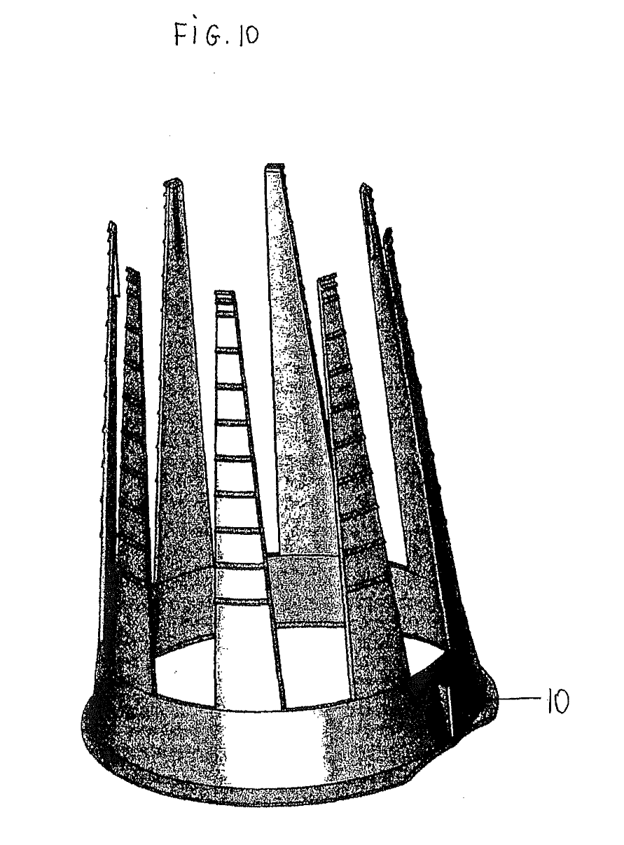

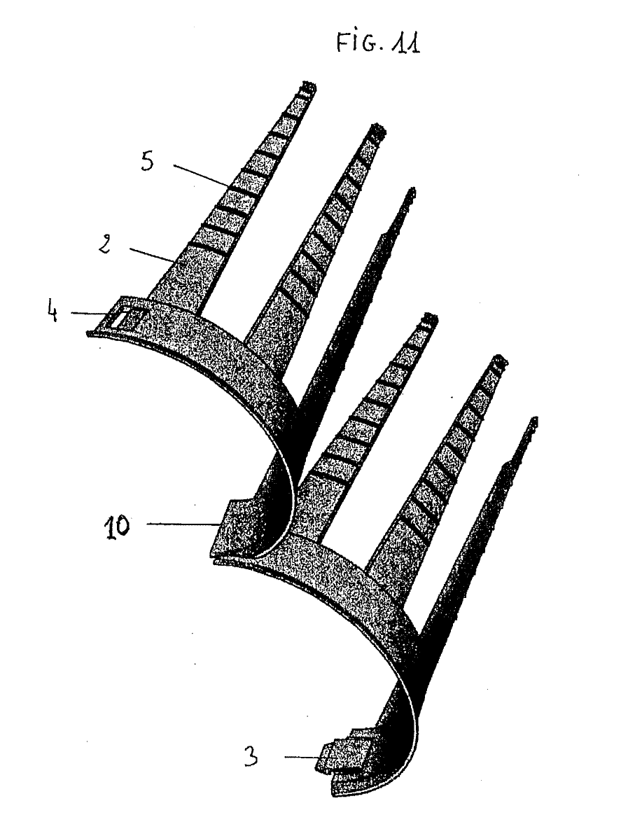

FIG. 10 illustrates the third embodiment of the device according to the present invention with the hinge (10).

FIG. 11 illustrates the third embodiment of the device according to the present invention in its open position (two half-cones).

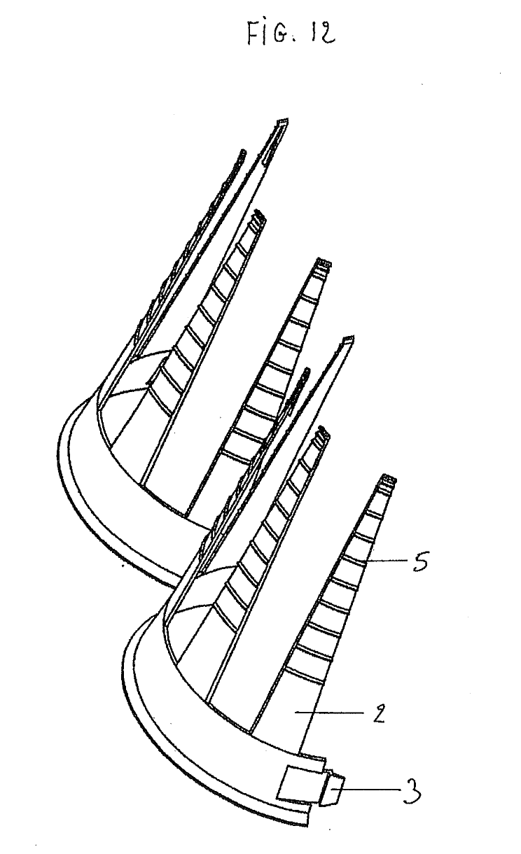

FIG. 12 illustrates another view of the third embodiment of the device according to the present invention in the open position (two half-cones or half-shells).

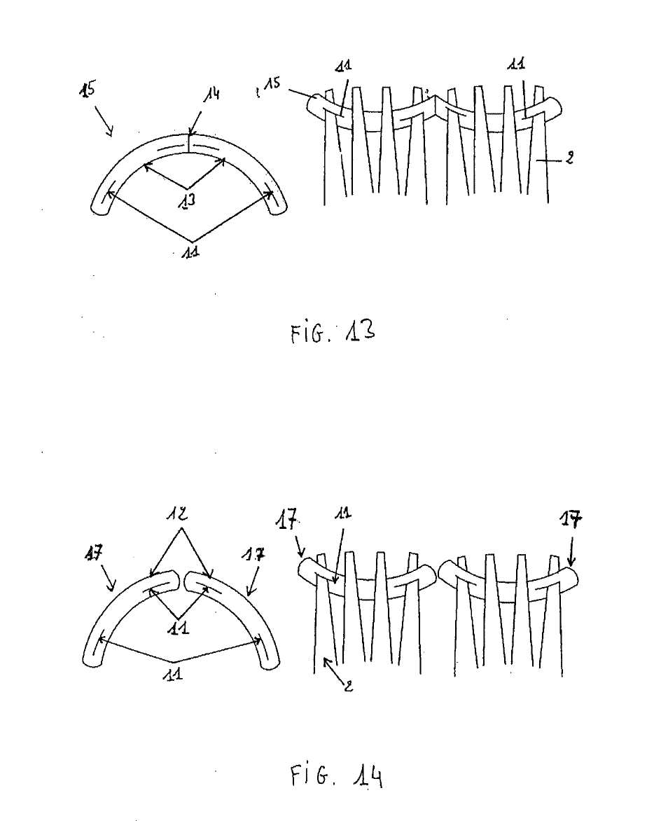

FIG. 13 illustrates a ring (15) having a hinge or fold (14) provided with insertion openings (11) for strip(s). At least one strip (2) cooperates with at least one insertion opening (11).

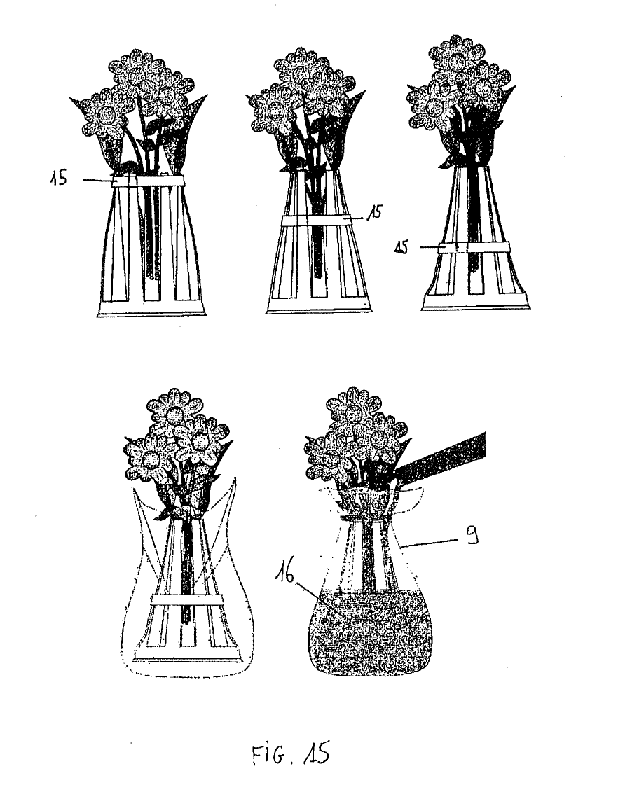

FIG. 14 illustrates at least two half-rings (17), said half-rings (17) are provided with insertion openings (11) for strip(s). At least one strip (2) cooperates with at least one insertion opening (11). Once the device is put into form the two half-rings (17) can be likened to a single ring (15).

FIG. 15 illustrates a support (1) comprising a ring (15) provided with insertion openings (11) for strip(s). First the ring (15) is positioned at the upper portion of the support (1), then is moved down toward the base of the support by the action of the user's hand to arrive in its final position causing the bouquet to be maintained in the vertical position. A watertight sheet (9) then surrounds the support (1) and water (16) can be poured inside the support (1).

The present invention consists of a support delivered either flat or in half-shell (half-cone section) or erected made up of strips (2) comprising retaining teeth (or notched strips), toped in its upper portion by an automatic closure ring (6).

Once the system is erected, the operator need only slide the bouquet inside said system and slide the ring (6), which causes peripheral tightening of the strips around the bouquet thereby guaranteeing complete stability and thus ensuring its maintenance in a single operation without having to use a fastening means. The stiff ring (6) has a smaller diameter than that of the support (1). The ring (6) grips the strips (2) by moving downward and it can be blocked in the ideal position either by the horizontal notching of the strips (2) or by any other rotation system ensuring its blocking.

The present invention concerns a device for displaying and keeping individual bouquets of flowers enabling the flowers to be maintained at the vertical central axis (7) of the erected device, comprising a support (1) from which strips (2) extend toward said vertical central axis (7), characterized in that the strips (2) have one or several retaining teeth (5) and in that an automatic closure ring (6) is in contact with said strips (2), said ring (6) making it possible to adjust the diameter of the variable opening of the erected device.

Each strip (2) can have between 1 and 50 retaining teeth (5), preferably between 2 and 10.

The closure ring (6) can be circular, cylindrical, conical, polygonal, triangular, square, pentagonal, hexagonal, heptagonal, octagonal, etc. in shape without, however, being limited to a special shape and the ring is made in a stiff material (plastic, glass, stiff metal, etc.) or in a flexible material (rubber, flexible metal or any other elastic material).

The device for displaying and keeping individual bouquets of flowers comprising the support (1) and the strips (2) can be cylindrical, conical, polygonal, triangular, square, pentagonal, hexagonal, heptagonal, octagonal, two half-cones, etc. in shape without, however, being limited to a special shape.

The closure ring (6) is kept in place by contact with a retaining tooth (5) by strip (2).

The support (1) can be foldable.

The support (1) can be equipped with a closure system made up of a male element (3) and a female element (4) in order to ensure the erection of the support (1).

The device according to the present invention can also form two half-cones connected by a hinge (10) situated on the support (1).

The device according to the present invention can be manufactured in a single piece making it possible to obtain a three-dimensional piece (1).

The support (1) of the device according to the present invention can comprise lugs (8), each lug (8) being located at the base of each strip (2).

The device according to the present invention comprises a watertight sheet (9) placed under the support (1) and raised along the strips (2), the device-watertight sheet (9) assembly being arranged to allow water to be introduced via the opening formed with the watertight sheet (9) and the strips (2) in the vicinity of the upper portion of the strips (2).

One alternative solution to the problem to be resolved by the present invention is to use a device for displaying and keeping individual bouquets of flowers making it possible to maintain the flowers at the vertical central axis (7) of the erected device, comprising a support (1) from which strips (2) extend toward said vertical central axis (7), characterized in that a closure ring (15) is provided with at least one insertion opening (11) cooperating with at least one strip (2), the ring (15)—strip (2) assembly making it possible to adjust the diameter of the variable opening of the strips of the erected device by sliding of the ring (15) along the strips (2) toward the base of the support (1). The closure ring (15) can be formed in a single piece or in several distinct elements (12) or in two elements (13) connected by a hinge (14) or able to be erected by folding (14) with or without male-female clipping. The strips (2) can be free of retaining teeth or provided with a plurality of retaining teeth. The ring (15) can be made up of a male element and a female element serving as closure for said ring (15). The ring (15) can also be provided without closure means. A watertight sheet (9) can be placed under the support (1) and raised along the strips (2), the assembly being arranged to allow water to be introduced through the opening formed with the watertight sheet (9) and the strips (2) in the vicinity of the upper portion of the strips (2).

The closure ring (15) can be made up of a single “block” (or single form) or two separate half-forms (17) provided or not with a closure system made up of a male element and a female element or can be made up of two half-forms connected by a hinge situated on the ring, said two half forms can be equipped or not with a closure system made up of a male element and a female element.

All of the embodiments of FIGS. 1 to 15 of the present invention can be combined with each other.

1.-9. (canceled)

10. A device for displaying and keeping individual bouquets of flowers, comprising:
a support formed about a vertical central axis;
a plurality of strips extending up from the support toward the central axis, the strips forming a variable diameter opening;
at least one retaining tooth disposed on each strip; and
an automatic closure ring in contact with the strips for adjusting the diameter of the opening.

11. The device according to claim 10, wherein each strip has two or more retaining teeth.

12. The device according to claim 10, wherein each strip has less than ten retaining teeth.

13. The device according to claim 10, wherein each strip has between two and ten retaining teeth.

14. The device according to claim 10, wherein each strip has up to fifty retaining teeth.

15. The device according to claim 10, wherein the closure ring is circular and is made from a stiff material.

16. The device according to claim 10, wherein the closure ring is made from a flexible material.

17. The device according to claim 10, wherein the closure ring is kept in place by contact with at least one of the at least one retaining tooth.

18. The device according to claim 10, wherein the support is foldable.

19. The device according to claim 18, wherein the support comprises:
a hinge.

20. The device according to claim 10, wherein the support comprises:
a closure system made up of a male element and a female element in order to ensure erection of the support.

21. The device according to claim 20, wherein the support comprises:
a hinge.

22. The device according to claim 10, wherein the support and the strips are manufactured from a single piece.

23. The device according to claim 10, further comprising:
a lug located at the base of each strip.

24. The device according to claim 10, further comprising:
a watertight sheet disposed under the support and raised along the strips;
whereby liquid may be introduced through an opening formed by the watertight sheet and the strips near the upper portions of the strips.
